(19) United States
(12) Patent Application Publication
(10) Pub. No.: US 2015/0325238 A1
(43) Pub. Date: Nov. 12, 2015

(54) Voice Recognition Method And Electronic Device

(71) Applicant: Lenovo (Beijing) Co., Ltd., Haidian District, Beijing (CN)

(72) Inventors: Haisheng Dai, Haidian District, Beijing (CN); Qianying Wang, Haidian District, Beijing (CN); Hao Wang, Haidian District, Beijing (CN)

(73) Assignee: Lenovo (Beijing) Co., Ltd., Haidian District, Beijing (CN)

(21) Appl. No.: 14/348,358

(22) PCT Filed: Aug. 29, 2013
(86) PCT No.: PCT/CN2013/082532

§ 371 Date: Mar. 28, 2014

(30) Foreign Application Priority Data
Aug. 29, 2012 (CN) 201210313453.0

(51) Int. Cl. G10L 15/197; G10L 15/06; G10L 15/22

(52) U.S. Cl. CPC G10L 15/197; G10L 15/22; G10L 15/063; G10L 2015/223; G10L 2015/0635

(57) ABSTRACT

A voice recognition method and an electronic device are described. The method is applicable in an electronic device having a voice recognition system. The method includes acquiring first voice information of a user; recognizing the first voice information on the basis of a first recognition file library, acquiring a first recognition result, where the first recognition file library is a recognition file library updated from a second recognition file library of the voice recognition system on the basis of usage information expressing usage and syntax habits of the user, the first recognition file library includes an M-number of recognition entries, the second recognition file library includes an N-number of recognition entries, where M is an integer greater than or equal to one, and N is an integer greater than or equal to one.

### BACKGROUND

The present invention relates to the field of computer technology, and particularly to voice recognizing method and electronic apparatus.

With the development of the technique of the electronic apparatus, various electronic apparatus have come into people's life, and with the development of voice recognizing technique, scenes in which the user controls the electronic apparatus with voice or interact with the electronic apparatus by voice become more and more ubiquitous, which brings great convenience to people's life.

In scenes of voice control or voice interaction, voice recognition is a very important step, and, in the procedure of the voice recognition, the voice recognition is carried out according to a grammar file (grammar), that is, the input voice information is matched with the grammar entry in the grammar file, and then the voice command corresponding to the voice information is acquired according to the result of match.

However, the inventor finds that in the procedure of implementing the technical solution of the embodiments of the present invention, since the grammar file in the prior arts is designed for all users, one voice command corresponds to a great amount of grammars, for example, the corresponding grammar of the voice command of “call Xiaoming” may be: “call Xiaoming”, “call up Xiaoming”, “help me to call Xiaoming”, and “I want to call Xiaoming”. And there are same grammar files for each specific user, and the grammar files are fixed, thus, for the specific user, the rate of the voice recognition is low, and so the efficiency of recognition is also low.

### SUMMARY

The embodiments of the present invention provide a voice recognizing method and an electronic apparatus for solving the technical problem that the rate of voice recognition and efficiency of voice recognition is low for specific user since the recognition document library directs to all users and is fixed in the voice recognition of the prior arts.

One aspect of the embodiments of the present invention provides a voice recognition method applied in an electronic apparatus having a voice recognition system, the method includes: acquiring first voice information of a user; recognizing the first voice information based on a first recognition document library to obtain a first recognition result, where, the first recognition document library is an updated recognition document library of a second recognition document library of the voice recognition system based on usage information characterizing usage grammar habit of the user, and the first recognition document library includes M recognition entries therein, the second recognition document library includes N recognition entries therein, M is an integer larger than or equal to one, and N is an integer larger than or equal to one.

Preferably, when the first recognition result represents that there is no recognition entry corresponding to the first voice information in the first recognition document library, the method further includes: converting the first voice information into a first recognition entry; and updating the first recognition entry into the first recognition document library.

Preferably, when the first recognition result represents that the first voice information corresponds to a first recognition entry in the M recognition entries, the method further includes: adjusting weight of each recognition entry in the M recognition entries based on the first recognition result.

Preferably, updating the second recognition document library of the voice recognition system based on the usage information characterizing the usage grammar habit of the user specifically includes: detecting frequency of being used of each recognition entry in the N recognition entries to obtain N detection results; adjusting weight of each recognition entry in the N recognition entries based on the N detection results to obtain M recognition entries; where, the weight is proportional to the frequency and M is equal to N.

Preferably, recognizing the first voice information based on the first recognition document library to obtain the first recognition result specifically includes: matching the first voice information with the M recognition entries respectively to obtain M scores; multiplying the M scores to the weight of the recognition entry corresponding to the respective M scores respectively to obtain M recognition results; determining a recognition entry corresponding to a result with the highest score in the M recognition results as the first recognition result.

Preferably, updating the second recognition document library of the voice recognition system based on the usage information characterizing the usage grammar habit of the user specifically includes: detecting times of being used of each recognition entry in the N recognition entries to obtain N detection results; determining recognition entry of which the times is less than a predetermined value based on the N detection results; deleting the recognition entry of which the times is less than the predetermined value from the second recognition document library to obtain the first recognition document library, where, M is less than N.

Preferably, after deleting the recognition entry of which the times is less than the predetermined value from the second recognition document library, the method further includes: storing the recognition entry of which the times is less than the predetermined value into a backup recognition document library.

Preferably, when the first recognition result represents that there is no recognition entry corresponding to the first voice information in the first recognition document library, the method further includes: recognizing the first voice information based on the backup recognition document library to obtain the second recognition result.

Preferably, when the second recognition result represents that the first voice information corresponds to a second recognition entry in the backup recognition document library, the method further includes: generating prompt information so that the user at the electronic apparatus side can confirm whether to accept the second recognition result; receiving acknowledge information; and updating the second recognition entry into the first recognition document library based on the acknowledge information.

Preferably, updating the second recognition document library of the voice recognition system based on the usage information characterizing the usage grammar habit of the user specifically includes: receiving an updating instruction; receiving input of a recognition entry based on the updating instruction; and updating the input recognition entry into the second recognition document library to obtain the first recognition document library, where, M is larger than N.

One embodiment of the present invention further provides an electronic apparatus having a voice recognition system, the electronic apparatus includes: a circuit board; an acquiring unit connected to the circuit board and for acquiring first voice information of a user; a voice recognizing chip provided on the circuit board and for recognizing the first voice information based on a first recognition document library to obtain a first recognition result, where, the first recognition document library is an updated recognition document library of a second recognition document library of the voice recognition system based on usage information characterizing usage grammar habit of the user, and the first recognition document library includes M recognition entries therein, the second recognition document library includes N recognition entries therein, M is an integer larger than or equal to one, and N is an integer larger than or equal to one.

Preferably, the electronic apparatus further include: a voice converting chip for converting the first voice information into a first recognition entry when the first recognition result represents that there is no recognition entry corresponding to the first voice information in the first recognition document library; and an updating chip for updating the first recognition entry into the first recognition document library.

Preferably, the electronic apparatus further includes an updating chip for adjusting weight of each recognition entry in the M recognition entries based on the first recognition result when the first recognition result represents that the first voice information corresponds to a first recognition entry in the M recognition entries.

Preferably, the electronic apparatus further includes an updating chip for detecting frequency of being used of each recognition entry in the N recognition entries to obtain N detection results; and adjusting weight of each recognition entry in the N recognition entries based on the N detection results to obtain M recognition entries, where, the weight is proportional to the frequency, and M is equal to N.

Preferably, the voice recognizing chip is specifically for matching the first voice information with the M recognition entries respectively to obtain M scores; multiplying the M scores to the weight of the recognition entry corresponding to the respective M scores respectively to obtain M recognition results; determining a recognition entry corresponding to a result with the highest score in the M recognition results as the first recognition result.

Preferably, the electronic apparatus further includes a first updating chip for detecting times of being used of each recognition entry in the N recognition entries to obtain N detection results; determining a recognition entry of which the times is less than a predetermined value based on the N detection results; deleting the recognition entry of which the times is less than a predetermined value from the second recognition document library to obtain the first recognition document library; where, M is less than N.

Preferably, the electronic apparatus further includes a backup recognition document library for storing the recognition entry of which the times is less than the predetermined value.

Preferably, the voice recognizing chip is further specifically for recognizing the first voice information based on the backup recognition document library to obtain the second recognition result when the first recognition result represents that there is no recognition entry corresponding to the first voice information in the first recognition document library.

Preferably, the electronic apparatus further include: an information generating chip for generating prompt information so that the user at the electronic apparatus side can confirm whether to accept the second recognition result and receiving acknowledge information when the second recognition result represents that the first voice information corresponds to a second recognition entry in the backup recognition document library; and a second updating chip for updating the second recognition entry into the first recognition document library based on the acknowledge information.

Preferably, the electronic apparatus further include: a receiving unit for receiving an update instruction; an input device for receiving the input of a recognition entry based on the updating instruction; and an updating chip for updating the input recognition entry into the second recognition document library to obtain the first recognition document library; where, M is larger than N.

One or more technical solutions provided by the embodiments of the present invention at least have the following technical effects or advantages:

The embodiments of the present invention recognize the voice information based on a recognition document library updated according to information of the usage grammar habit of the user in the procedure of the voice recognition, and since the recognition entry in the recognition document library is more compliant with the usage habit of the user, the rate of voice recognition is increased and also the efficiency of the voice recognition is increased.

Further, updating the recognition document library specifically according to the usage grammar habit of the user in the embodiments of the present invention is adjusting the weight of the recognition entry in the recognition document library, so the rate of accuracy of the voice recognition is increased.

Still further, updating the recognition document library specifically according to the usage grammar habit of the user in the embodiments of the present invention is deleting the recognition entry that the user does not use or of which the times of usage is particularly few from the recognition document library directly or storing the recognition entry in the backup recognition document library, in so doing, the data amount of the match when the voice information is matched in the procedure of the voice recognition is reduced and the time of match is saved, so as to increase the rate of recognition. Further, when there is the backup recognition document library, the recognition document library simplified is matched, and when there is no match, the backup recognition document library is further matched, so the rate of recognition is not caused to lower due to the recognition entry being deleted.

### BRIEF DESCRIPTION OF THE DRAWINGS

FIG. 1 is a flow chart of the voice recognition method of the embodiments of the present invention; and

FIG. 2 is a functional block diagram of the electronic apparatus of the embodiments of the present invention.

### DETAILED DESCRIPTION

The embodiments of the present invention provide a voice recognizing method and an electronic apparatus for solving the technical problem that the rate of voice recognition and the efficiency of voice recognition are low for specific user since the recognition document library directs to all users and is fixed in the voice recognition of the prior arts.

The overall concept of the technical solution in the embodiments of the present invention for solving the above technical problem is as follows:

The recognition entries in the recognition document library are optimized in steps by learning the usage grammar habit of the user, and then the voice input of the user is recognized based on the optimized recognition document library. Since the recognition entries in the optimized recognition document library are more compliant with the usage habit of the user, the rate of the voice recognition is increased, and also the efficiency of the voice recognition is increased.

For understanding the above-described technical solution better, the above-described technical solution is explained in detail in combination with the accompanying drawings of the specification and the specific implementation modes.

The embodiment of the present invention provides a voice recognition method applied in an electronic apparatus having a voice recognition system, the electronic apparatus is for example an electronic apparatus such as a mobile phone, a tablet computer, a notebook computer.

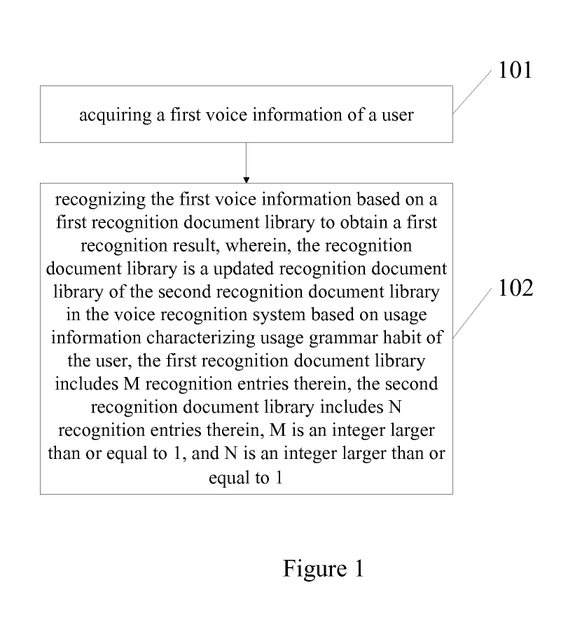

With reference to FIG. 1, the method includes:

Step 101: obtaining the first voice information of a user;

Step 102: recognizing the first voice information based on a first recognition document library to obtain a first recognition result, where, the first recognition document library is an updated recognition document library of the second recognition document library in the voice recognition system based on usage information characterizing usage grammar habit of the user, the first recognition document library includes M recognition entries therein, the second recognition document library includes N recognition entries therein, M is an integer larger than or equal to one, and N is an integer larger than or equal to one.

In step 101, the first voice information of the user is obtained, and the first voice information is specifically for example voice information recorded by a microphone or a microphone array of the electronic apparatus.

In step 102, the first voice information is recognized based on the first recognition document library to obtain the first recognition result. In this embodiment, the first recognition document library is for example a grammar file, and the M recognition entries are grammar entries. Since the grammar entry is text information and the first voice information input is not text information, when the first voice information is matched with the M recognition entries, the first voice information is matched after being converted into the text information. Or, the M recognition entries are converted into character strings of phoneme, and the first voice information is also converted into character strings of phoneme by an acoustic model, and then they are matched.

How to update the second recognition document library based on the usage information characterizing the usage grammar habit of the user to obtain the first recognition document library is explained in detail as follows.

In the first embodiment, the step of updating specifically includes: detecting frequency of being used of each recognition entry in the N recognition entries to obtain N detection results; adjusting weight of each recognition entry in the N recognition entries based on the N detection results to obtain M recognition entries; where, the weight is proportional to the frequency, and M is equal to N.

In particular, for example, the voice command is “call Xiaoming”, which corresponds to four kinds of grammar, that is, there are four grammar entries in the second recognition document library, which are respectively “call Xiaoming”, “call up Xiaoming”, “help me to call Xiaoming” and “I want to call Xiaoming”. Every time the user wants to execute the voice command of “call Xiaoming” by inputting voice information, times of the user using the respective grammar entries are recorded. For example, the user input the voice command of “call Xiaoming” 10 times in all, wherein, the grammar entry of “call Xiaoming” is used 3 times, the grammar entry of “call up Xiaoming” is used 4 times, the grammar entry of “help me to call Xiaoming” is used 2 times, and the grammar entry of “I want to call Xiaoming” is used 1 time, then the frequency of using the grammar entry of “call Xiaoming” is 3/10, the frequency of using the grammar entry of “call up Xiaoming” is 2/5, the frequency of using the grammar entry of “help me to call Xiaoming” is 1/5, and the frequency of using the grammar entry of “I want to call Xiaoming” is 1/10. Of course, in the specific implementation procedure, the frequency of being used can be characterized by the times of usage directly.

After obtaining the four detection results, i.e., frequency value of each grammar entry, the weight of each recognition entry in the four grammar entries are adjusted based on the four detection results to obtain the first recognition document library. In this embodiment, the number of the recognition entry in the first recognition document library is equal to the number of the recognition entry in the second recognition document library.

The specific implementation modes of adjusting the weight of the recognition entry based on the detection result may be various, for example, an adjusting rule can be preset, for example, the weight of the recognition entry is adjusted to conform to the frequency of being used of the recognition entry, that is, if the frequency of being used is characterized by the times of usage, the weight is the times of usage divided by the total times, and, if the frequency of being used is characterized by the times of usage divided by the total times, the weight value is the same as the frequency of being used. Continue to use the above-described example, the weight of the grammar entry of “call Xiaoming” is adjusted to 3/10, the weight of the grammar entry of “call up Xiaoming” is adjusted to 2/5, the weight of the grammar entry of “help me to call Xiaoming” is adjusted to 1/5, and the weight of the grammar entry of “I want to call Xiaoming” is adjusted to 1/10.

Also for example, the weight of each recognition entry is a function of the frequency of being used of the recognition entry, so the weight value of the recognition entry can be obtained by substituting the frequency value into the functional relationship to calculate.

Further, in order to ensure increase of the entirety of the rate of recognition, regardless of according to which kind of the above-described mode the weight of each recognition entry is adjusted, the weight of each recognition entry has an upper value of adjustment, that is, at the time of being below this upper value, the weight become larger, and the rate of recognition is increased. But, when the upper value is exceeded, as the weight becomes larger, the rate of recognition would decrease.

In this embodiment, after adjusting the weight of the recognition entry in the second recognition document library by the above-described mode, executing step 102 specifically includes: matching the first voice information with the M recognition entries respectively to obtain M scores; multiplying the M scores to the weight of the recognition entry corresponding to the respective M scores respectively to obtain M recognition results; determining a recognition entry corresponding to a result with the highest score in the M recognition results as the first recognition result.

In particular, continue to use the above-described example, after the user inputs the first voice information, for example, “call up Xiaoming”, the electronic apparatus matches the first voice information with the above-described four grammar entries respectively to obtain four scores. For example, after being matched with the grammar entry of “call Xiaoming”, the score obtained is 91, after being matched with the grammar entry of “call up Xiaoming”, the score obtained is 90, after being matched with the grammar entry of “help me to call Xiaoming”, the score obtained is 87, and after being matched with the grammar entry of “I want to call Xiaoming”, the score obtained is 89.

And then the four scores are multiplied to the weight of the respective corresponding grammar entries respectively, for example, the score of matching of 91 of the grammar entry of “call Xiaoming” is multiplied to the weight 3/10, and the recognition result is 27.1, the score of matching of 90 of the grammar entry of “call up Xiaoming” is multiplied to the weight 2/5, and the recognition result is 36, the score of matching of 87 of the grammar entry of “help me to call Xiaoming” is multiplied to the weight 1/5, and the recognition result is 17.4, similarly, the score of matching of 89 of the grammar entry of “I want to call Xiaoming” is multiplied to the weight 1/10, and the recognition result is 8.9.

And then the recognition entry corresponding to the result having the highest score in the four recognition results is selected as the first recognition result, for example, in the above-described example, the grammar entry corresponding to the result having the highest score in the recognition results is “call up Xiaoming”, so the first voice information is recognized accurately. And then an operational instruction corresponding to the first voice information is executed, for example, contact “Xiaoming” is found out in the contact list and the phone number stored in the name of “Xiaoming” is dialed automatically. However, if it is recognized by the method in the prior arts, the ultimate recognition result is “call Xiaoming”, so the recognition result is not accurate sufficiently, and the rate of recognition is low.

In the above-described example, though the procedure described is matching the first voice information with all of the recognition entries respectively firstly and then multiplied to the corresponding weights, in the specific application procedure, a first recognition entry can be matched firstly to obtain a score and the product of the score and the weight is calculated next to obtain a recognition result, and then, the next recognition entry is matched until all of the recognition entries that need to be matched are matched.

In this embodiment, when the ultimate recognition result is “call up Xiaoming”, the frequency of being used or times of being used of the grammar entry are changed, so the weight of each recognition entry in the M recognition entries is adjusted once again based on the first recognition result, that is, each recognition entry has a new weight. And, when there is voice information that needs to be recognized next time, the new weight is adopted to calculate.

Therefore, the electronic apparatus optimizes the recognition document library in steps by learning the usage grammar habit of the user, so the rate of recognition is increased.

In the second embodiment, the updating step specifically includes: detecting times of being used of each recognition entry in the N recognition entries to obtain N detection results; determining the recognition entry of which the times is less than a predetermined value based on the N detection result; deleting the recognition entry of which the times is less than a predetermined value from the second recognition document library to obtain the first recognition document library; where, M is less than N.

Continue to use the above example, for example, the user inputs the voice command of “call Xiaoming” 10 times in all, the grammar entry of “call Xiaoming” is used 3 times, the grammar entry of “call up Xiaoming” is used 4 times, the grammar entry of “help me to call Xiaoming” is used 2 times, and the grammar entry of “I want to call Xiaoming” is used 1 time.

In this embodiment, it is assumed that the predetermined value of the times is 2, then the recognition entry of which the times is less than the predetermined value is “I want to call Xiaoming”, and this recognition entry is deleted from the second recognition document library to obtain the first recognition document library. Thus, in this embodiment, M is less than N.

Therefore, at the time of recognizing the first voice information based on the first recognition document library in step 102, the data amount of the matching is reduced, so the amount of calculation is reduced, and time is saved.

Further, the deleted recognition entry in the above-described embodiment can be stored in a backup recognition document library, when the first recognition result represents that there is no recognition entry corresponding to the first voice information in the first recognition document library in step 102, the first voice information is recognized based on the backup recognition document library to obtain the second recognition result. In this embodiment, there being no recognition entry corresponding to the first voice information in the first recognition document library may mean: the score of the matching of the first voice information with all of the recognition entries is zero; or may mean: the max score of the matching of the first voice information with all of the recognition entries is less than a predetermined value, or the max product of the score of the matching to the weight is less than a predetermined value.

In particular, continue to use the above example to explain, when the first voice information is “I want to call Xiaoming” and the first voice information is matched in the first recognition document library, for example, the max score is 20, and the predetermined value is 50, at this time, it can be decided that there is no recognition entry corresponding to the first voice information in the first recognition document library, so the first voice information is matched in the backup recognition document library to obtain the second recognition result.

Therefore, the above-described two kinds of implementation modes are combined, if a satisfactory first recognition result is obtained in the first recognition document library, there is no match in the backup recognition document library, so the amount and time of calculation is reduced; and, if the match in the first recognition document library is not successful, it further recognizes in the backup recognition document library, so it does not cause the rate of recognition to be low due to this.

In a further embodiment, when the second recognition result represents that the first voice information corresponds to the second recognition entry in the backup recognition document library, for example, the score corresponding to the second recognition result is higher than the score of the first recognition result, or the score corresponding to the second recognition result is not zero, the method further includes: generating prompt information so that the user at the electronic apparatus side can confirm whether to accept the second recognition result; receiving acknowledge information; and updating the second recognition entry into the first recognition document library based on the acknowledge information.

In particular, for example, the prompting information can be displayed on a display unit of the electronic apparatus to make the user confirm whether the second recognition result is the voice command that he wants, and after the user clicks the acknowledge button, the electronic apparatus receives acknowledge information. And then, the second recognition entry is updated into the first recognition document library based on the acknowledge information.

In the third embodiment, the updating step may include: receiving an updating instruction; receiving the input of a recognition entry based on the updating instruction; and updating the input recognition entry into the second recognition document library to obtain the first recognition document library; where, M is larger than N.

For example, in one embodiment, when the user wants to update the recognition document library, the user can enter an interface of modification through an option button, and from the perspective of the electronic apparatus, an updating instruction is received. Then, the user can input a new recognition entry on this interface by a keyboard or a touch display unit, and from the perspective of the electronic apparatus, input of the recognition entry is received. And then, the recognition entry input by the user is updated into the second recognition document library to obtain the first recognition document library, and M is larger than N in this embodiment.

In another embodiment, it may be converting the first voice information into a first recognition entry when the first recognition result represents that there is no recognition entry corresponding to the first voice information in the first recognition document library in step 102; and updating the first recognition entry into the first recognition document library.

In this embodiment, there being no recognition entry corresponding to the first voice information in the first recognition document library may mean: the score of the matching of the first voice information with all of the recognition entries is zero; or may mean: the max score of the matching of the first voice information with all of the recognition entries is less than a predetermined value, or the max product of the score of the matching to the weight is less than a predetermined value. For example, the first voice information is “I want to call Xiaoming Li”.

Since the recognition entry is the text information, the first voice information can't be stored in the recognition document library directly, therefore, the first voice information needs to be converted into a recognition entry, i.e., text information, and then the recognition entry is updated into the first recognition document library. When there is voice information that needs to be recognized next time, it is recognized according to the updated recognition document library. Thus, the recognition document library is updated automatically according to the usage grammar habit of the user, so that the rate of the voice recognition is increased.

In the above-described respective embodiments, though the recognition document library only embodies the recognition document library of one voice command, that is, it only includes grammar entries corresponding to the voice command, in practical application, there may include grammar entries of a plurality of voice commands in the recognition document library. And, though the number is more than that in the above-described embodiment, but for the grammar entry corresponding to each voice command, it can be updated according to the method of the above-described respective embodiments similarly.

One embodiment of the present invention further provides an electronic apparatus which is for example an electronic apparatus such as a mobile phone, a tablet computer, a notebook computer, and the electronic apparatus has a voice recognition system.

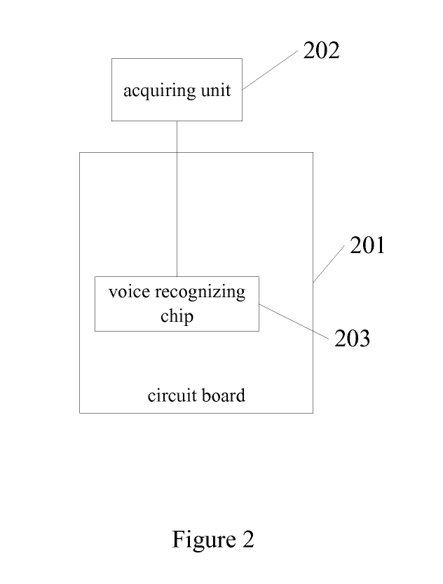

As shown in FIG. 2, the electronic apparatus includes: a circuit board 201; an acquiring unit 202 connected to the circuit board 201 and for acquiring first voice information of a user; a voice recognizing chip 203 provided on the circuit board 201 and for recognizing the first voice information based on a first recognition document library to obtain a first recognition result, where, the first recognition document library is an updated recognition document library of a second recognition document library of the voice recognition system based on usage information characterizing usage grammar habit of the user, and the first recognition document library includes M recognition entries therein, the second recognition document library includes N recognition entries therein, M is an integer larger than or equal to one, and N is an integer larger than or equal to one.

Further, the electronic apparatus further includes: a voice converting chip for converting the first voice information into a first recognition entry when the first recognition result represents that there is no recognition entry corresponding to the first voice information in the first recognition document library; and an updating chip for updating the first recognition entry into the first recognition document library. The voice converting chip and the updating chip can be integrated into the voice recognizing chip 203, or they are chips independent from the voice recognizing chip 203.

In another embodiment, the electronic apparatus further includes an updating chip for adjusting weight of each recognition entry in the M recognition entries based on the first recognition result when the first recognition result represents that the first voice information corresponds to a first recognition entry in the M recognition entries.

In another embodiment, the electronic apparatus further includes an updating chip for detecting frequency of being used of each recognition entry in the N recognition entries to obtain N detection results; adjusting the weight of each recognition entry in the N recognition entries based on the N detection results to obtain M recognition entries; where, the weight is proportional to the frequency, and M is equal to N.

Further, the voice recognizing chip 203 is specifically for matching the first voice information with the M recognition entries respectively to obtain M scores; multiplying the M scores to the weight of the recognition entry corresponding to the respective M scores respectively to obtain M recognition results; determining a recognition entry corresponding to a result with the highest score in the M recognition results as the first recognition result.

In another embodiment, the electronic apparatus further includes a first updating chip for detecting times of being used of each recognition entry in the N recognition entries to obtain N detection results; determining a recognition entry of which the times is less than a predetermined value based on the N detection results; deleting the recognition entry of which the times is less than a predetermined value from the second recognition document library to obtain the first recognition document library; where, M is less than N.

Further, the electronic apparatus also includes a backup recognition document library for storing the recognition entry of which the times is less than a predetermined value.

Further, the voice recognizing chip 203 is further specifically for recognizing the first voice information based on the backup recognition document library to obtain the second recognition result when the first recognition result represents that there is no recognition entry corresponding to the first voice information in the first recognition document library.

Further, the electronic apparatus further include: an information generating chip for generating prompt information so that the user at the electronic apparatus side can confirm whether to accept the second recognition result and receive acknowledge information when the second recognition result represents that the first voice information corresponds to a second recognition entry in the backup recognition document library; and a second updating chip for updating the second recognition entry into the first recognition document library based on the acknowledge information.

In another embodiment, the electronic apparatus further includes: a receiving unit for receiving an updating instruction; an input device for receiving the input of a recognition entry based on the updating instruction; and an updating chip for updating the input recognition entry into the second recognition document library to obtain the first recognition document library; where, M is larger than N.

The above respective embodiments can be implemented individually or in combination with each other, those skilled in the art can make an option according to actual requirement.

The various modified manners and specific examples in the voice recognition method of the above-mentioned embodiment with reference to FIG. 1 can be applied in the electronic apparatus of the present embodiment likewise, and those skilled in the art can understand the implementation method of the electronic apparatus in the present embodiment by the detailed description of the above voice recognition method, thus detailed description is no longer provided herein for the simplicity of the specification.

One or more technical solutions provided by the embodiments of the present invention at least have the following technical effects or advantages:

The embodiments of the present invention recognize the voice information based on a recognition document library updated according to information of the usage grammar habit of the user in the procedure of the voice recognition, and since the recognition entry in the recognition document library are more compliant with the usage habit of the user, the rate of voice recognition is increased and also the efficiency of the voice recognition is increased.

Further, the recognition document library is updated specifically according to the usage grammar habit of the user in the embodiments of the present invention, and the weight of the recognition entry in the recognition document library is adjusted, so the rate of accuracy of the voice recognition is increased.

Still further, updating the recognition document library specifically according to the usage grammar habit of the user in the embodiments of the present invention is deleting the recognition entry that the user does not use or of which the times of usage is particularly few from the recognition document library directly or storing the recognition entry in the backup recognition document library, in so doing, the data amount of the match when the voice information is matched in the procedure of the voice recognition is reduced and the time of match is saved, so as to increase the rate of recognition. Further, when there is the backup recognition document library, the recognition document library simplified is matched, and when there is no match, the backup recognition document library is further matched, so the rate of recognition is not caused to lower due to the recognition entry being deleted.

Those skilled in the art should understand that, the embodiments of the present invention can be provided as a method, a system or a computer program product. Therefore, the present invention can adopt forms of a full hardware embodiment, a full software embodiment, or an embodiment combining software and hardware aspects. And, the present invention can adopt forms of one or more computer program products implemented on a computer usable storage medium (including, but not limited to a magnetic disk storage, an optical memory, or the like) including computer usable program codes.

The present invention is described by referring to flow charts and/or block diagrams of the method, the apparatus (system) and the computer program product according to the embodiments of the present invention. It should be understood that each flow and/or block in the flow charts and/or block diagrams and the combination of the flow and/or block in the flow charts and/or block diagrams can be implemented by computer program instructions. These computer program instructions can be provided to processors of a general purpose computer, a dedicated computer, an embedded processor or other programmable data processing apparatus to generate a machine, so that a device for implementing functions specified in one or more flows of the flow charts and/or one or more blocks of the block diagrams is generated by the instruction executed by the processor of the computer or other programmable data processing apparatus.

These computer program instructions can also be stored in a computer readable storage which is able to direct the computer or other programmable data processing apparatus to operate in specific manners, so that the instructions stored in the computer readable storage generate manufactured articles including a commander equipment, which implements functions specified by one or more flows in the flow charts and/or one or more blocks in the block diagrams.

These computer program instructions can be loaded to a computer or other programmable data processing apparatus, so that a series of operation steps are executed on the computer or other programmable apparatus to generate computer implemented process, so that the instructions executed on the computer or other programmable apparatus provide steps for implementing functions specified in one or more flows of the flow charts and/or one or more blocks of the block diagrams.

It is obvious that those skilled in the art can make various modifications and variations to the present invention without departing from the spirit and scope of the present invention. Thus, if these modifications and variations of the present invention fall within the scope of the claims of the present invention and the equivalent technology, the present invention intends to comprise these modifications and variations.

1. A voice recognition method applied in an electronic apparatus having a voice recognition system, wherein the method comprises:
acquiring first voice information of a user; and
recognizing the first voice information based on a first recognition document library to obtain a first recognition result, wherein, the first recognition document library is an updated recognition document library of a second recognition document library in the voice recognition system based on usage information characterizing usage grammar habit of the user, the first recognition document library includes M recognition entries therein, the second recognition document library includes N recognition entries therein, M is an integer larger than or equal to one, and N is an integer larger than or equal to one.

2. The method according to claim 1, wherein, when the first recognition result represents that there is no recognition entry corresponding to the first voice information in the first recognition document library, the method further includes:
converting the first voice information into a first recognition entry; and
updating the first recognition entry into the first recognition document library.

3. The method according to claim 1, wherein, when the first recognition result represents that the first voice information corresponds to the first recognition entry in the M recognition entries, the method further includes: adjusting weight of each recognition entry in the M recognition entries based on the first recognition result.

4. The method according to claim 1, wherein,
updating the second recognition document library of the voice recognition system based on the usage information characterizing the usage grammar habit of the user comprises:
detecting a frequency of being used of each recognition entry in the N recognition entries to obtain N detection results; and
adjusting a weight of each recognition entry in the N recognition entries based on the N detection results to obtain M recognition entries; wherein, the weight is proportional to the frequency, and M is equal to N.

5. The method according to claim 4, wherein, recognizing the first voice information based on the first recognition document library to obtain the first recognition result comprises:
matching the first voice information with the M recognition entries respectively to obtain M scores;
multiplying the M scores to the weights of the respective recognition entries corresponding to the M scores respectively to obtain M recognition results; and
determining a recognition entry corresponding to a result having the highest score in the M recognition results as the first recognition result.

6. The method according to claim 1, wherein,
updating the second recognition document library of the voice recognition system based on the usage information characterizing the usage grammar habit of the user comprises:
detecting times of being used of each recognition entry in the N recognition entries to obtain N detection results;
determining a recognition entry of which the times is less than a predetermined value based on the N detection results; and
deleting the recognition entry of which the times is less than a predetermined value from the second recognition document library to obtain the first recognition document library; wherein, M is less than N.

7. The method according to claim 6, wherein, after deleting the recognition entry of which the times is less than the predetermined value from the second recognition document library, the method further includes: storing the recognition entry of which the times is less than the predetermined value in a backup recognition document library.

8. The method according to claim 7, wherein, when the first recognition result represents that there is no recognition entry corresponding to the first voice information in the first recognition document library, the method further includes: recognizing the first voice information based on the backup recognition document library to obtain the second recognition result.

9. The method according to claim 8, wherein, when the second recognition result represents that the first voice information corresponds to a second recognition entry in the backup recognition document library, the method further includes:
generating prompt information so that the user at the electronic apparatus side can confirm whether to accept the second recognition result;
receiving acknowledge information; and
updating the second recognition entry into the first recognition document library based on the acknowledge information.

10. The method according to claim 1, wherein, updating the second recognition document library of the voice recognition system based on the usage information characterizing the usage grammar habit of the user comprises:
receiving an updating instruction;
receiving input of a recognition entry based on the updating instruction; and
updating the input recognition entry into the second recognition document library to obtain the first recognition document library; wherein, M is larger than N.

11. An electronic apparatus having a voice recognition system, wherein, the electronic apparatus comprises:
a circuit board;
an acquiring unit connected to the circuit board and configured to acquire first voice information of a user;
a voice recognizing chip provided on the circuit board and configured to recognize the first voice information based on a first recognition document library to obtain a first recognition result, wherein, the first recognition document library is an updated recognition document library of a second recognition document library in the voice recognition system based on usage information characterizing usage grammar habit of the user, the first recognition document library includes M recognition entries therein, and the second recognition document library includes N recognition entries therein, M is an integer larger than or equal to one, and N is an integer larger than or equal to one.

12. The electronic apparatus according to claim 11, wherein, the electronic apparatus further includes:
a voice converting chip configured to convert the first voice information into a first recognition entry when the first recognition result represents that there is no recognition entry corresponding to the first voice information in the first recognition document library; and
an updating chip configured to update the first recognition entry into the first recognition document library.

13. The electronic apparatus according to claim 11, wherein, the electronic apparatus further includes an updating chip configured to adjust a weight of each recognition entry in the M recognition entries based on the first recognition result when the first recognition result represents that the first voice information corresponds to a first recognition entry in the M recognition entries.

14. The electronic apparatus according to claim 11, wherein, the electronic apparatus further includes an updating chip configured to detect a frequency of being used of each recognition entry in the N recognition entries to obtain N detection results; and adjusting weight of each recognition entry in the N recognition entries based on the N detection results to obtain M recognition entries; wherein, the weight is proportional to the frequency, and M is equal to N.

15. The electronic apparatus according to claim 14, wherein, the voice recognizing chip is configured to match the first voice information with the M recognition entries respectively to obtain M scores; multiplying the M scores to the weight of the respective recognition entry corresponding to the M scores respectively to obtain M recognition results; and determining a recognition entry corresponding to a result with the highest score in the M recognition results as the first recognition result.

16. The electronic apparatus according to claim 11, wherein, the electronic apparatus further includes a first updating chip configured to detect times of being used of each recognition entry in the N recognition entries to obtain N detection results; determining recognition entry of which the times is less than a predetermined value; and deleting the recognition entry of which the times is less than the predetermined value from the second recognition document library to obtain the first recognition document library; wherein, M is less than N.

17. The electronic apparatus according to claim 16, wherein, the electronic apparatus further includes a backup recognition document library configured to store the recognition entry of which the times is less than the predetermined value.

18. The electronic apparatus according to claim 17, wherein, the voice recognizing chip is further configured to recognize the first voice information based on the backup recognition document library to obtain a second recognition result when the first recognition result represents that there is no recognition entry corresponding to the first voice information in the first recognition document library.

19. The electronic apparatus according to claim 18, wherein, the electronic apparatus further includes:
an information generating chip configured to generate prompt information so that the user at the electronic apparatus side can confirm whether to accept the second recognition result and receiving acknowledge information when the second recognition result represents that the first voice information corresponds to a second recognition entry in the backup recognition document library; and
a second updating chip configured to update the second recognition entry into the first recognition document library based on the acknowledge information.

20. The electronic apparatus according to claim 11, wherein, the electronic apparatus further includes:
a receiving unit configured to receive an updating instruction;
an input device configured to receive input of a recognition entry based on the updating instruction; and
an updating chip configured to update the input recognition entry into the second recognition document library to obtain the first recognition document library; wherein, M is larger than N.
